(19) United States
(12) Patent Application Publication
(10) Pub. No.: US 2017/0096962 A1
(43) Pub. Date: Apr. 6, 2017

(54) THROAT AREA CONTROL SYSTEM

(71) Applicant: Aerojet Rocketdyne, Inc., Sacramento, CA (US)

(72) Inventors: Guy Spear, Orange, VA (US); Ted Smith, Orange, VA (US); Michael Gagne, Orange, VA (US)

(21) Appl. No.: 15/204,205

(22) Filed: Jul. 7, 2016

Related U.S. Application Data
(60) Provisional application No. 62/191,996, filed on Jul. 13, 2015.

(51) Int. Cl. F02K 1/15

(52) U.S. Cl. CPC F02K 1/15

(57) ABSTRACT

A system includes a combustion chamber that has a throat, and a regulator for changing area cross-sectional area of the throat. The regulator includes a first piston in fluid connection with the combustor, and a second piston that is moveable with the first piston. The second piston at least partially defining the throat.

### CROSS-REFERENCE TO RELATED APPLICATION

The present disclosure claims priority to U.S. Provisional Patent Application No. 62/191,996, filed Jul. 13, 2015.

### BACKGROUND

Rockets and other similar vehicles typically include a combustor that discharges combustion products through a throat region. The throat region may be configured according to predesignated conditions, such as a boost state. At other conditions or states the combustor may operate less efficiently than at the predesignated conditions. There are various types of controls that may be used at the throat region to vary the throat area. Such controls often utilize sophisticated electronics, actuators, or pyrotechnics.

### SUMMARY

A system according to an example of the present disclosure includes a combustion chamber having a throat, and a regulator for changing a cross-sectional area of the throat. The regulator has a first piston in fluid connection with the combustion chamber, and a second piston moveable with the first piston. The second piston at least partially defines the throat.

In a further embodiment of any of the foregoing embodiments, the first piston has a first effective cross-sectional area, the second piston has a second effective cross-sectional area, and the first effective cross-sectional area is greater than the second effective cross-sectional area.

In a further embodiment of any of the foregoing embodiments, the regulator further includes a damper coupled with the first piston.

A further embodiment of any of the foregoing embodiment includes a bias member configured to preload the first piston.

In a further embodiment of any of the foregoing embodiments, the bias member includes a spring.

In a further embodiment of any of the foregoing embodiments, the bias member is selected from the group consisting of a spring, a dashpot, a magnet, a piezoelectric, a pressure actuator, and combinations thereof.

In a further embodiment of any of the foregoing embodiments, the bias member includes a dashpot.

In a further embodiment of any of the foregoing embodiments, the regulator includes a tap at which the combustion chamber fluidly connects with the regulator, and the tap is positioned intermediate of the first piston and the throat.

In a further embodiment of any of the foregoing embodiments, the second piston is coupled in a mechanical joint with the first piston.

In a further embodiment of any of the foregoing embodiments, the mechanical joint is selected from the group consisting of a mechanical interlock joint, a bonded joint, an interference fit joint, a fastened joint, and combinations thereof.

A system according to an example of the present disclosure includes a combustor chamber having a throat defining a cross-sectional area, a regulator, and a pressure feedback line fluidly connecting the regulator and the combustor chamber. The regulator has at least one piston that is moveable responsive to the pressure feedback line to move in the throat and change the cross-sectional area of the throat.

In a further embodiment of any of the foregoing embodiments, the at least one piston includes two pistons of different effective cross-sectional areas.

In a further embodiment of any of the foregoing embodiments, the regulator and pressure feedback line are configured such that increases in pressure in the pressure feedback line retract the at least one piston and increase the area of the throat.

In a further embodiment of any of the foregoing embodiments, the regulator further includes a damper coupled with the at least one piston.

In a further embodiment of any of the foregoing embodiments, the at least one piston is biased with a preload.

A vehicle according to an example of the present disclosure includes a vehicle body and a combustor having a combustion chamber. The combustor is operable to propel the vehicle body. The combustion chamber has a throat, and a regulator for changing area cross-sectional area of the throat. The regulator includes a first piston in fluid connection with the combustion chamber, and a second piston moveable with the first piston. The second piston at least partially defines the throat.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example vehicle and regulator system.

FIG. 2 further illustrates the regulator system of FIG. 1.

FIG. 3 illustrates another example regulator system.

### DETAILED DESCRIPTION

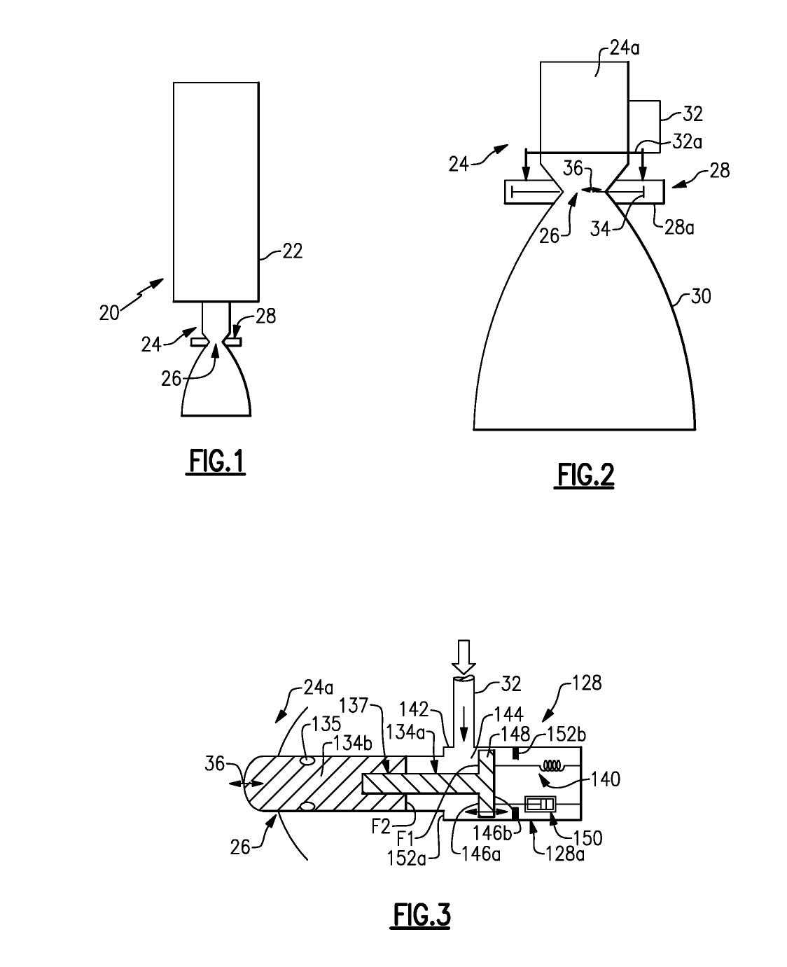

FIG. 1 schematically illustrates an example vehicle 20. The vehicle includes a vehicle body 22 and a combustor 24 that is mounted to the vehicle body and operable to propel the vehicle 20. The combustor 24 may be in a solid rocket motor or liquid rocket engine, for example. In a solid rocket motor the combustor 24 is in a case and in a liquid rocket engine the combustor 24 is within a wall. The combustor 24 includes a throat 26 and a control or regulator system 28 for changing area cross-sectional area of the throat 26. The throat 26 is the region of the combustor 24 that has the minimum cross-sectional area. As an example, the vehicle 20 may be a rocket, but other combustor-propelled vehicles will also benefit from the examples herein.

FIG. 2 further illustrates the regulator system 28, which includes the combustor 24. The combustor 24 includes a combustion chamber 24a that converges to the throat 26. In this example, the throat 26 opens to a nozzle portion 30.

The regulator system 28 also includes a regulator 28a and a pressure feedback line 32 that fluidly connects the regulator 28a and the combustion chamber 24a. Although not shown, the pressure feedback line 32 may include a check valve or the like to limit back-pressure. The regulator 28a includes one or more pistons 34 that are acted upon by pressure within the pressure feedback line 32 (i.e., the pistons 34 are moveable responsive to the pressure in the pressure feedback line 32). The pistons 34 are differential area passive devices. The one or more pistons 34 move in the throat 26, as represented at 36, to change the cross-sectional area of the throat 26. That is, the one or more pistons 34 can extend into, and retract from, the throat 26 to vary the cross-sectional area of the throat and thus variably block flow through the throat 26. As shown, the regulator system 28 includes two such regulators 28a on opposed sides of the throat 26.

The pressure feedback line 32 conveys the instant pressure in the combustion chamber 24a to the regulators 28a via a manifold portion 32a of the pressure feedback line 32. There may be a pressure loss in such pressure conveyance. The pressure conveyed by the pressure feedback line 32 acts on the one or more pistons 34 and thus moves the one or more pistons 34 in accordance with the pressure in the combustion chamber 24a. For instance, when an instant pressure in the combustion chamber 24a decreases, the pressure decrease causes extension of the one or more pistons 34 into the throat 26, thereby reducing the cross-sectional area of the throat 26. The decrease in the cross-sectional area of the throat 26 increases pressure, which in turn increases burn rate and flow. Inversely, when an instant pressure in the combustion chamber 24a increases, the pressure increase causes retraction of the one or more pistons 34 from the throat 26, thereby increasing the cross-section of the throat 26. The increase in the cross-sectional area of the throat 26 reduces pressure, which in turn reduces burn rate and flow. The regulator system 28 thus operates passively in response to the instant pressure in the combustion chamber 24a to adjust the area of the throat 26. The regulator system 28 may therefore reduce or eliminate the need for control electronics, actuators, and pyrotechnics.

FIG. 3 illustrates another example regulator system 128 and regulator 128a. In this disclosure, like reference numerals designate like elements where appropriate and reference numerals with the addition of one-hundred or multiples thereof designate modified elements that are understood to incorporate the same features and benefits of the corresponding elements. Here, the regulator 128a includes a first piston 134a in fluid connection with the combustion chamber 24a via pressure feedback line 32, and a second piston 134b that is moveable with the first piston 134a. One or more seals 135 may be provided around the second piston 134b to limit pressure leakage.

The first and second pistons 134a/134b may be coupled in a mechanical joint 137, such as but not limited to, a mechanical interlock joint, a bonded joint, an interference fit, a fastened joint, or the like. Alternatively, the first and second pistons 134a/134b are integral as a single, monolithic piece. The first and second pistons 134a/134b thus move in unison such that movement of the first piston 134a causes movement of the second piston 134b in the throat 26, to change the area of the throat 26.

The regulator 128a further includes a bias member 140 that is configured to preload the first piston 134a. For example, the bias member 140 is a spring, a magnet, a piezoelectric, a pressure actuator, or a combination of these.

In this example, the pressure feedback line 32 fluidly connects with the regulator 128a at an inlet or tap 142 such that pressure is fed to a cavity 144 adjacent the first piston 134a. The tap 142 is positioned intermediate of the first piston 134a and the throat 26. Such an arrangement feeds the pressure to the throat side 146a of a head 148 of the first piston 134a. The bias member 140 is located at an opposed back side 146b of the head 148 such that the pressure acts on the throat side 146a against the preload force of the bias member 140 at the back side 146b.

In this example, the first piston 134a has a first effective cross-sectional area, represented at F1. The second piston 134b has a second cross-sectional area, represented at F2. The first effective cross-sectional area F1 is greater than the second effective cross-sectional area F2. The difference in the cross-sectional areas F1 and F2 serves as an area reduction to enable the pressure of the pressure feedback line 32 to move the first piston 134a and the second piston 134b against the preload force of the bias member 140. For instance, the cross-sectional areas F1 and F2 and preload force of the bias member 140 can be selected with respect to the expected pressure range in the cavity 144 (from the combustion chamber 24a, considering any pressure loss). The pistons 134a/134b thus move over a desired pressure range. In particular, in a “sustain” stage of propulsion there may be pressure variations in the combustor 24 that can cause inefficiencies. The movement of the pistons 134a/134b to open/close the area of the throat 26 serves to passively return or bias the pressure in the combustion chamber 24a to a predetermined level, which may enhance specific impulse and performance The differential cross-sectional areas F1 and F2 can thus be used to set the force balance loads on the piston 134b.

The bias member 140 of the regulator 128a may further include a damper 150 coupled with the first piston 134a. The damper 150 serves to control the rate of movement of the first piston 134a and thus also of the second piston 134b. For instance, relatively large pressure changes might otherwise cause the pistons 134a/134b to move at a high rate. However, the damper 150 serves to “smooth” the movement of the pistons 134a/134b by limiting the rate of movement for large pressure swings. For example, the damper 150 is a mechanical or hydraulic damper. In a further example, the damper 150 includes a dashpot.

The regulator 128a may further include a stop 152a that limits the extension stroke of the pistons 134a/134b. The stop 152a is positioned with respect to the axial length of the pistons 134a/134b and maximum extension into the throat 26. For instance, the stop 152a is positioned such that at maximum extension the second piston 134b only partially blocks the throat 26. That is, at a minimum, the stroke length of the pistons 134a/134b is less than the diametric size of the throat 26. This ensures that the throat 26 is always at least partially open. There may also be stop 152b that is positioned with respect to the axial length of the pistons 134a/134b and maximum retraction from the throat 26. For instance, the stop 152b is positioned such that at maximum retraction the second piston 134b does not withdraw outboard beyond the throat 26.

The first piston 134a and the second piston 134b may have different temperature exposures in the regulator 128a. For example, the first piston 134a may generally be exposed to cooler temperatures than the second piston 134b, which extends in the throat 26 and is thus directly exposed to hot combustion gases. In this regard, the first piston 134a may be formed of a first material and the second piston 134b may be formed of a second material different from the first material in composition. For instance, the first material may be a lower temperature-resistance material in comparison to the second material. The first and second materials may be selected from, but are not limited to, metal alloys and ceramic materials. The metal alloys may include refractory metal-based alloys. The ceramic material may include monolithic ceramics and ceramic matrix composites.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A system comprising:
a combustion chamber having a throat; and
a regulator for changing a cross-sectional area of the throat, the regulator including,
a first piston in fluid connection with the combustion chamber, and
a second piston moveable with the first piston, the second piston at least partially defining the throat.

2. The system as recited in claim 1, wherein the first piston has a first effective cross-sectional area, the second piston has a second effective cross-sectional area, and the first effective cross-sectional area is greater than the second effective cross-sectional area.

3. The system as recited in claim 1, wherein the regulator further includes a damper coupled with the first piston.

4. The system as recited in claim 1, further comprising a bias member configured to preload the first piston.

5. The system as recited in claim 4, wherein the bias member includes a spring.

6. The system as recited in claim 4, wherein the bias member is selected from the group consisting of a spring, a dashpot, a magnet, a piezoelectric, a pressure actuator, and combinations thereof.

7. The system as recited in claim 4, wherein the bias member includes a dashpot.

8. The system as recited in claim 1, wherein the regulator includes a tap at which the combustion chamber fluidly connects with the regulator, and the tap is positioned intermediate of the first piston and the throat.

9. The system as recited in claim 1, wherein the second piston is coupled in a mechanical joint with the first piston.

10. The system as recited in claim 8, wherein the mechanical joint is selected from the group consisting of a mechanical interlock joint, a bonded joint, an interference fit joint, a fastened joint, and combinations thereof.

11. A system comprising:
a combustor chamber having a throat defining a cross-sectional area;
a regulator; and
a pressure feedback line fluidly connecting the regulator and the combustor chamber, the regulator including at least one piston that is moveable responsive to the pressure feedback line to move in the throat and change the cross-sectional area of the throat.

12. The system as recited in claim 11, wherein the at least one piston includes two pistons of different effective cross-sectional areas.

13. The system as recited in claim 11, wherein the regulator and pressure feedback line are configured such that increases in pressure in the pressure feedback line retract the at least one piston and increase the area of the throat.

14. The system as recited in claim 11, wherein the regulator further includes a damper coupled with the at least one piston.

15. The system as recited in claim 11, wherein the at least one piston is biased with a preload.

16. A vehicle comprising:
a vehicle body;
a combustor having a combustion chamber, the combustor operable to propel the vehicle body, the combustion chamber having a throat; and
a regulator for changing area cross-sectional area of the throat, the regulator including,
a first piston in fluid connection with the combustion chamber, and
a second piston moveable with the first piston, the second piston at least partially defining the throat.
